(19) United States
(12) Patent Application Publication
(10) Pub. No.: US 2026/0347668 A1
(43) Pub. Date: Nov. 5, 2026

(54) PROCESSES FOR MAKING LAMINATED SHEETS

(71) Applicants: Dow Global Technologies LLC, Midland, MI (US); Dow Silicones Corporation, Midland, MI (US)

(72) Inventors: Zhenbin Niu, Midland, MI (US); Arkady L. Krasovskiy, Lake Jackson, TX (US); Nanguo Liu, Midland, MI (US); Lori Dehlin, Midland, MI (US); Paul R. Vlasak, Midland, MI (US)

(73) Assignees: Dow Global Technologies LLC, Midland, MI (US); Dow Silicones Corporation, Midland, MI (US)

(21) Appl. No.: 19/491,543

(22) PCT Filed: Jun. 27, 2024
(86) PCT No.: PCT/US2024/035811

§ 371 Date: Dec. 9, 2025

Related U.S. Application Data
(60) Provisional application No. 63/511,044, filed on Jun. 29, 2023.

(51) Int. Cl. C09J 7/40; B32B 7/06; B32B 7/12; B32B 37/02; B32B 37/12; G09F 3/02; G09F 3/10

(52) U.S. Cl. CPC C09J 7/401; B32B 7/06; B32B 7/12; B32B 37/02; B32B 37/12; G09F 3/02; G09F 3/10; C09J 2451/005; G09F 2003/0225

(57) ABSTRACT

One process for making a laminated sheet may comprise applying an uncured adhesive to a removable layer such that a first surface of the removable layer is in direct contact with an uncured adhesive, curing the uncured adhesive to form a cured adhesive layer positioned in direct contact with the first surface of the removable layer, applying a release liner in direct contact with the cured adhesive layer such that the cured adhesive layer is positioned between the removable layer and the release liner. Another process for making a laminated sheet may comprise applying an uncured adhesive to a release liner such that a first surface of the release liner is in direct contact with an uncured adhesive, curing the uncured adhesive to form a cured adhesive layer positioned in direct contact with the first surface of the release liner, and applying a removable layer in direct contact with the cured adhesive layer such that the cured adhesive layer is positioned between the removable layer and the release liner. The release liner may comprise a copolymer comprising low density polyethylene and one or more functionalized polysiloxanes. The functionalized polysiloxanes may be chosen from (meth)acrylic ester functionalized polysiloxane and vinyl functionalized polysiloxane.

### CROSS-REFERENCE TO RELATED APPLICATIONS

This application claims the benefit of U.S. Provisional Application Ser. No. 63/511,044 filed Jun. 29, 2023, the contents of which are incorporated in their entirety herein.

### TECHNICAL FIELD

The present disclosure generally relates to laminated sheets and, more specifically, to methods for making laminated sheets.

### BACKGROUND

Laminated sheets have a wide variety of uses in industry. For example, some laminated sheets may selectively removable layers, such as stickers or labels. These stickers or labels may be removed from a backing film as desired by the user and then applied to a substrate. Such laminated sheets can be used for many decorative and functional purposes, and may vary widely in color and design. For example, labels on packaging, foods, or other consumer products are widely utilized in industry. However, new and/or improved methods for making laminated sheets are desired.

### BRIEF SUMMARY

Embodiments of the present disclosure may meet those needs by providing new processes for making laminated sheets which utilize a specialized copolymer composition in the release liner. The laminated films described herein may generally include a release liner, an adhesive, and a removable layer. Such embodiments can be utilized as stickers and/or labels, where the removable layer and adhesive are separated from the release liner. The copolymer composition described herein incorporates a (meth)acrylic ester functionalized polysiloxane. In such embodiments, the release liner may not need a specialized top coating, such as silicone, as is common in conventional embodiments. Instead, the copolymer may have acceptable release characteristics without need for other specialized layers that add cost and complexity to the processes.

According to one or more embodiments of the present disclosure, a process for making a laminated sheet may comprise applying an uncured adhesive to a removable layer such that a first surface of the removable layer is in direct contact with an uncured adhesive, curing the uncured adhesive to form a cured adhesive layer positioned in direct contact with the first surface of the removable layer, applying a release liner in direct contact with the cured adhesive layer such that the cured adhesive layer is positioned between the removable layer and the release liner. The release liner may comprise a copolymer comprising low density polyethylene and one or more functionalized polysiloxanes. The functionalized polysiloxanes may be chosen from (meth)acrylic ester functionalized polysiloxane and vinyl functionalized polysiloxane.

According to one or more additional embodiments of the present disclosure, a process for making a laminated sheet may comprise applying an uncured adhesive to a release liner such that a first surface of the release liner is in direct contact with an uncured adhesive, curing the uncured adhesive to form a cured adhesive layer positioned in direct contact with the first surface of the release liner, and applying a removable layer in direct contact with the cured adhesive layer such that the cured adhesive layer is positioned between the removable layer and the release liner. The release liner may comprise a copolymer comprising low density polyethylene and one or more functionalized polysiloxanes. The functionalized polysiloxanes may be chosen from (meth)acrylic ester functionalized polysiloxane and vinyl functionalized polysiloxane.

These and other embodiments are described in more detail in the Detailed Description. It is to be understood that both the foregoing general description and the following detailed description present embodiments of the technology, and are intended to provide an overview or framework for understanding the nature and character of the technology as it is claimed. The accompanying drawings are included to provide a further understanding of the technology, and are incorporated into and constitute a part of this specification. The drawings illustrate various embodiments and together with the description serve to explain the principles and operations of the technology. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a schematic depiction of a flow-chart for a process for making a laminated sheet, according to one or more embodiments disclosed herein;

FIG. 2 is a schematic depiction of a flow-chart for a process for making a laminated sheet, according to one or more embodiments disclosed herein; and

FIG. 3 is a schematic depiction of a continuous process for making a laminated sheet, according to one or more embodiments disclosed herein.

Additional features and advantages of the present disclosure will be set forth in the detailed description, which follows, and in part will be apparent to those skilled in the art from that description or recognized by practicing the embodiments described herein, including the detailed description, which follows the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein, and together with the description, explain the principles and operations of the claimed subject matter.

### DETAILED DESCRIPTION

Specific embodiments of the present application will now be described. The disclosure may, however, be embodied in different forms and should not be construed as limited to the embodiments set forth in this disclosure. Rather, these embodiments are provided so that this disclosure will be thorough and complete and will fully convey the scope of the subject matter to those skilled in the art.

Described herein are processes for making laminated sheets that include a release liner, a central adhesive layer, and a removable layer (sometimes called facestock in industry). Such laminated sheets may be utilized for securing removable layers such as stickers or other labels prior to application on a product. As is described herein, according to embodiments, the unique composition of the release liner provides advantages as compared to convention release liners, making manufacturing, in some embodiments, easier and less costly.

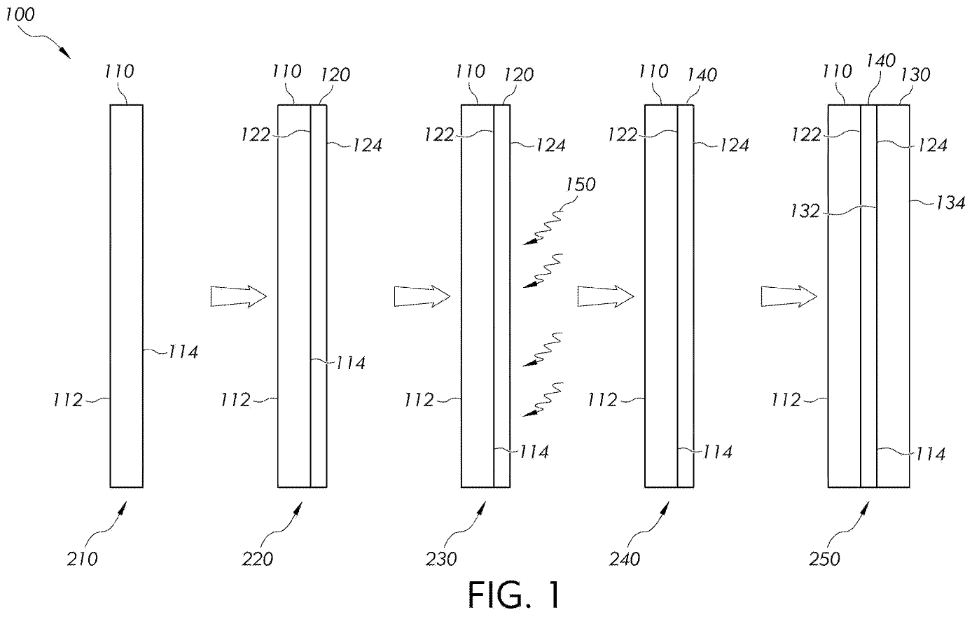

FIG. 1 provides a schematic representation of a first embodiment of one or more processes described herein, where an adhesive is applied to a removable layer, and a release liner is then applied onto the adhesive layer following curing of the adhesive layer.

Referring now to FIG. 1 in detail, on the left side of process 100, a removable layer 110 is shown. The removable layer 110 (shown as uncoated removable layer 210) may include a first surface 114 opposite a second surface 112. The removable layer 110 may have the geometry of a sheet, with much greater dimensions in the length and width directions than thickness. The removable layer 110 may be a sticker or label, sometimes called facestock. For example, removable layer 110 may comprise, without limitation, paper, vinyl, polyester, polypropylene, foil, fabric, or combinations thereof. The removable layer 110 may be a composite layer or laminated layer with multiple sub-layers. However, the material of the removable layer 110 is not necessarily limited in terms of materials in the embodiments described herein.

Still referring to FIG. 1, the process 100 for making laminated sheets may include applying an uncured adhesive 120 to the removable layer 110 such that a first surface 114 of the removable layer 110 is in direct contact with an uncured adhesive 120 (shown as coated removable layer 220). For example, the uncured adhesive 120, typically in liquid phase, may include surface 122 and 124, where surface 122 is in direct contact with the first surface 114 of the removable layer 110. The composition of the adhesive is not necessarily limited, and it is contemplated that many types and grades of adhesives may be applicable. Without limitation, contemplated adhesives include acrylic adhesives, rubber adhesives, hot melt adhesives, water-based adhesives, solvent-based adhesives, pressure sensitive adhesives, synthetic rubber adhesives.

Still referring to FIG. 1, the process 100 may further include curing the uncured adhesive 120 to form a cured adhesive layer 140 positioned in direct contact with the first layer 114 of the removable layer 110. Coated removable layer 230 is shown undergoing curing. Cured, coated removable layer 240 is depicted following the curing step. As described herein, curing is a process of inducing a chemical reaction in a material, typically a polymer, in order to change its physical properties and/or promote adhesion to a substrate. During curing, the polymer chains may crosslink with one another, leading to an increase in molecular weight and the formation of a solid, durable structure. Curing can be accomplished through various methods, including exposure to heat, radiation (e.g., visible or UV light), or a chemical catalyst, depending on the composition of the adhesive material. The resulting cured material is typically more resistant to chemical and physical degradation, and may exhibit improved strength, flexibility, and other desirable properties. Rays 150 are representative of heat or light, which may be utilized for curing.

The process 100 may further include applying a release liner 130 into direct contact with the cured adhesive layer 140, such that the cured adhesive layer 140 is positioned between the removable layer 110 and the release liner 130 (shown as laminated sheet 250 in FIG. 1). The release liner 130 may include a first surface 134 opposite a second surface 132. The release liner 130 may have the geometry of a sheet, with much greater dimensions in the length and width directions than thickness. As is described in detail herein, the release liner 130 may comprise a polymer composition comprising polyethylene and a reaction product of the copolymerization of the ethylene and (meth)acrylic ester functionalized polysiloxane, and optionally one or more units derived from a termonomer. This polymer composition is disclosed in detail later herein, along with its functionality.

Generally, the release liner 130 may have a homogenous composition throughout its entire body. That is, the release liner 130 may not include multiple layers of material, such as a substrate and a separate silicone layer. As such, the presently disclosed processes may avoid a silicone liner application step that is common in conventional embodiments. For example, conventional processes may apply a liquid silicone to a substrate sheet, and then cure the silicone in an oven to arrive at the equivalent of release liner 130.

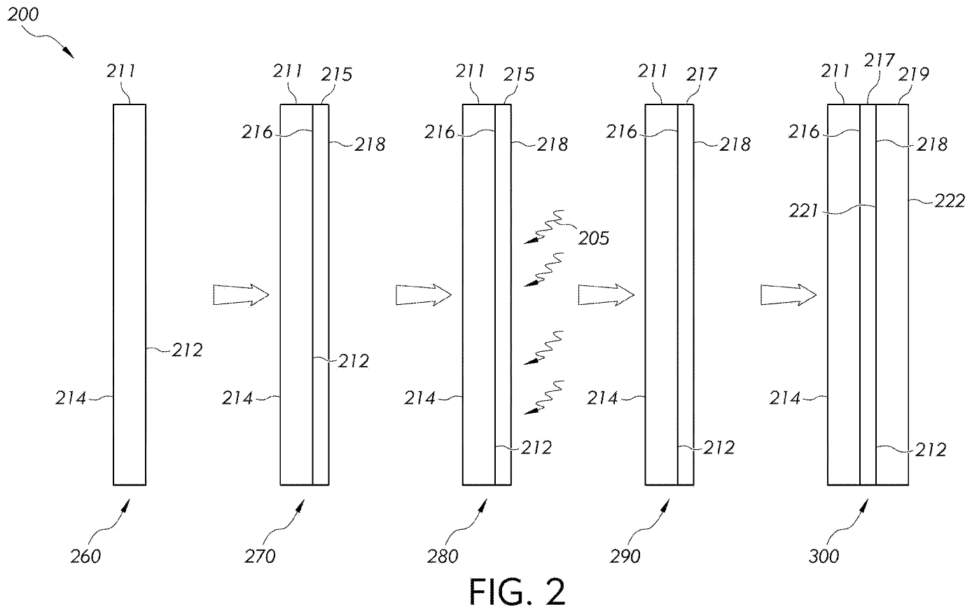

FIG. 2 provides a schematic representation of a second embodiment of one or more processes described herein, where an adhesive is applied to a release liner, and a removable layer is then applied onto the adhesive layer following curing of the adhesive layer.

Referring now to FIG. 2 in detail, on the left side of process 200, a release liner 211 is shown. The release liner 211 (shown as uncoated release liner 260) may include a first surface 212 opposite a second surface 214. The release liner 211 may have the geometry of a sheet, with much greater dimensions in the length and width directions than thickness. As is described in detail herein, the release liner 211 may comprise a polymer composition comprising polyethylene and a reaction product of the copolymerization of the ethylene and (meth)acrylic ester functionalized polysiloxane, and optionally one or more units derived from a termonomer. This polymer composition is disclosed in detail later herein, along with its functionality. That is, the release liner 211 may not include multiple layers of material, such as a substrate and a separate silicone layer. As such, the presently disclosed processes may avoid a silicone liner application step that is common in conventional embodiments. For example, conventional processes may apply a liquid silicone to a substrate sheet, and then cure the silicone in an oven to arrive at the equivalent of release liner 211.

Still referring to FIG. 2, the process 200 for making laminated sheets may include applying an uncured adhesive 215 to the release liner 211 such that a first surface 212 of the release liner 211 is in direct contact with an uncured adhesive 215 (shown as coated release liner 270). For example, the uncured adhesive 215, typically in liquid phase, may include surface 216 and 218, where surface 216 is in direct contact with the first surface 212 of the release liner 211. The composition of the adhesive is not necessarily limited, and it is contemplated that many types and grades of adhesives may be applicable. Without limitation, contemplated adhesives include acrylic adhesives, rubber adhesives, hot melt adhesives, water-based adhesives, solvent-based adhesives, pressure sensitive adhesives, synthetic rubber adhesives.

Still referring to FIG. 2, the process 200 may further include curing the uncured adhesive 215 to form a cured adhesive layer 217 positioned in direct contact with the first layer 212 of the release liner 211. Coated release liner 280 is shown undergoing curing. Cured, coated release liner 290 is depicted following the curing step. As described herein, curing is a process of inducing a chemical reaction in a material, typically a polymer, in order to change its physical properties and/or promote adhesion to a substrate. During curing, the polymer chains may crosslink with one another, leading to an increase in molecular weight and the formation of a solid, durable structure. Curing can be accomplished through various methods, including exposure to heat, radiation (e.g., visible or UV light), or a chemical catalyst, depending on the composition of the adhesive material. The resulting cured material is typically more resistant to chemical and physical degradation, and may exhibit improved strength, flexibility, and other desirable properties. Rays 205 are representative of heat or light, which may be utilized for curing.

The process 200 may further include applying a removable layer 219 into direct contact with the cured adhesive layer 217, such that the cured adhesive layer 217 is positioned between the removable layer 219 and the release liner 211 (shown as laminated sheet 300 in FIG. 2). The removable layer 219 may include a first surface 221 opposite a second surface 222. The removable layer 219 may have the geometry of a sheet, with much greater dimensions in the length and width directions than thickness. The removable layer 219 may be a sticker or label, sometimes called facestock. For example, removable layer 219 may comprise, without limitation, paper, vinyl, polyester, polypropylene, foil, fabric, or combinations thereof. The removable layer 219 may be a composite layer or laminated layer with multiple sub-layers. However, the material of the removable layer 219 is not necessarily limited in terms of materials in the embodiments described herein.

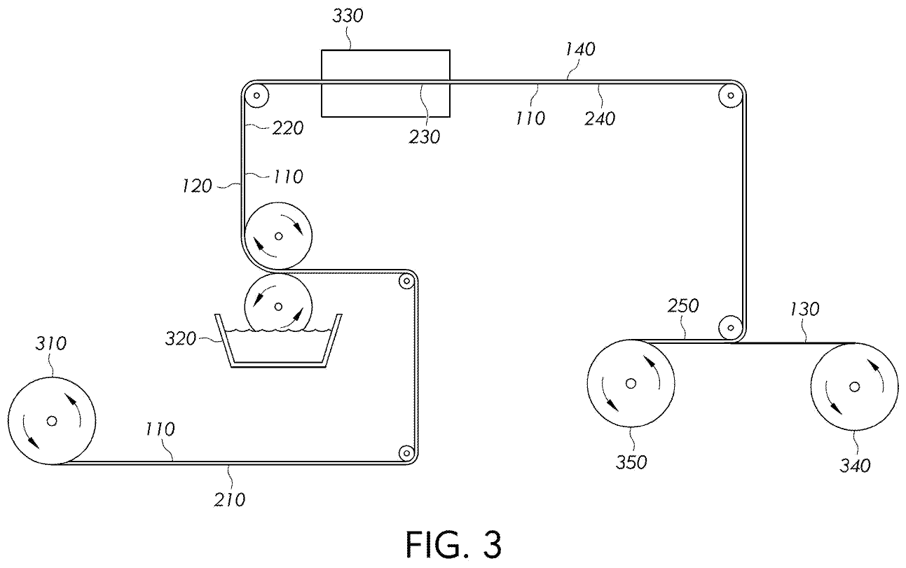

According to additional embodiments, the process 100 of FIG. 1 or the process 200 of FIG. 2 may be carried out in a continuous process. For instance, FIG. 3 depicts the formation of a laminated sheet in a continuous process according to process 100 of FIG. 1. As shown in FIG. 3, roll 310 may house the uncoated removable layer 210. The uncoated removable layer 210 may move in a machine direction towards a coating apparatus 320, which may supply the uncured adhesive 120. As described herein, the machine direction refers to the direction in which the removable layer 110 moves onto or into a processing machine, such as any roller or the coating apparatus 320 or curing apparatus 330, discussed later herein. The machine direction may be different in different portions of the process, such as if rollers re-orient the directional movement of the removable layer 110 as shown in FIG. 3.

As is depicted in FIG. 3, the uncoated removable layer 210 may be passed to a coating apparatus 320, where the uncured adhesive 120 may be applied onto the removable layer 110 as the removable layer 110 is translated in a machine direction. The coating apparatus 320 is not necessarily limited in structure or function, but in some embodiments may include two wheels where one wheel applies the uncured adhesive 120. Following processing at the coating apparatus 320, the coated removable layer 220 is passed to the curing apparatus 330. In the curing apparatus 330, curing the uncured adhesive 120 to form a cured adhesive 140 may take place as the removable layer 110 is translated in the machine direction. The curing apparatus 330 may include an oven, light, or any other suitable equipment to affect curing on the uncured adhesive 120.

Following processing in the curing apparatus 330, the cured, coated removable layer 240 may be passed to a junction point where the release liner 130 is applied to the cured, coated removable layer 240 to from the laminated sheet 250. The release liner 130 may be housed on roll 340, and the laminated sheet 250 may be ultimately housed on roll 350. In such embodiments, the release liner 130 may be applied as the removable layer 110 is translated in the machine direction. Downstream of FIG. 3, the laminated sheet 250 may be cut and/or the removable layer 110 along with the cured adhesive 140 may be separated from the release liner 130. A laminated sheet could be formed via a similar continuous process according to process 200 of FIG. 2.

While FIG. 3 depicts the scheme of FIG. 1, one skilled in the art could implement the apparatus of FIG. 3 for the scheme of FIG. 2, and such embodiments are contemplated herein.

As described herein, the release liner 130 may comprise, consist, or consist essentially of copolymers of low density polyethylene (sometimes referred to as “ethylene polymer” or “LDPE” herein) and functionalized polysiloxane, such as a functionalized polydimethylsiloxane (sometimes referred to as “f-PDMS” herein). In some instances, the copolymer may be described as LDPE-co-PDMS, which refers to a copolymer of f-PDMS and LDPE. However, it should be understood that when describing attributes of LDPE-co-PDMS, embodiments that include other siloxanes than PDMS are contemplated to sometimes have those same attributes.

The presently described release liners are generally homogenous in compositions (e.g., single layered), which is different from conventional embodiments. Conventional embodiments may utilized a top coating of, for example, silicone, which enables adequate release characteristics. However, it has been presently discovered that the herein disclosed composition utilized in the release liner 130 may provide for adequate releaseability without the need for an additional release layer, such as a silicone layer.

In embodiments, the copolymers may be formed by high pressure, free-radical polymerization by reacting ethylene monomer and functionalized polysiloxane, or by reacting ethylene monomer and a mixture of functionalized polysiloxanes. In embodiments, functionalized polysiloxane may be attached to the high pressure ethylene polymer via several covalent bonds that result from the reaction of the initial function of the functionalized polysiloxane with growing propagating chain of the ethylene polymer followed up by further reaction with ethylene monomers, and may also include bridging between functional group that gets polymerized and siloxane.

In embodiments, the copolymer may include from 0.1 wt % to 50 wt % of functionalized polysiloxane, such as f-PDMS, such as from 0.1 wt % to 20 wt %, from 0.5 wt % to 20 wt %, from 2.0 wt % to 20 wt %, from 2.0 wt % to 15 wt %, from 2.0 wt % to 12 wt %, from 2.0 wt % to 10 wt %, from 1.0 wt % to 10 wt %, from 5 wt % to 10 wt %, or from 5.0 wt % to 20 wt %, based on a total weight of the copolymer.

In various embodiments, the copolymer comprises one or more of the following structures, but not limited to:

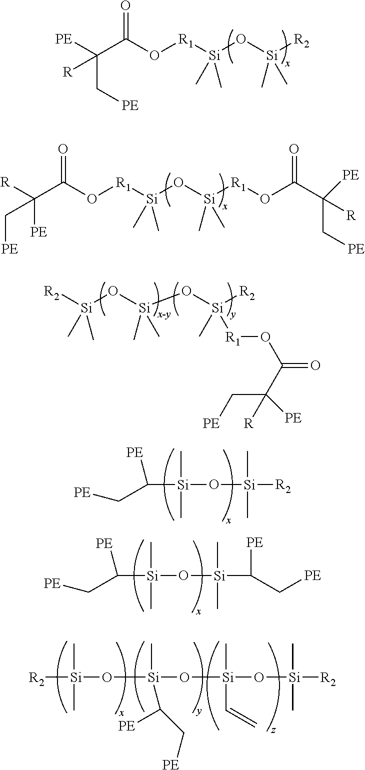

where R is methyl or hydrogen, R¹ is a bridge group that connects functional group ((meth)acrylate) with siloxane, R² is an end group selected from the group consisting of alkyl, substituted alkyl, aryl, alkenyl, H, and OH, x is an integer from 10 to 1000, and y is an integer from 1 to 30, and z is an integer from 0 to 30, and r+z is less than or equal to 30. R¹ and R² groups can be the same or different.

In embodiments, the bridge group of the LDPE-co-PDMS may be selected from substituted or unsubstituted C₂-C₂₀ alkylene linker where one or more carbon atoms can be substituted with oxygen and/or silicon, a substituted or unsubstituted aryl group, and derivatives and combinations thereof. In embodiments, the functional group bound to the bridge group may be bound to the high pressure ethylene polymer by means of copolymerization with ethylene monomer. In various embodiments, the functional group is a (meth)acrylate ester group. In further embodiments, the bridge group is the group depicted below:

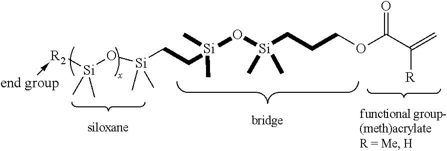

In the structural formulas above, the ethylene-based polymeric branch is depicted as being a polyethylene (PE), which may be indicative of LDPE.

The copolymer may comprises a polysiloxane unit, which in embodiments, is derived from functionalized polydimethylsiloxane (e.g., f-PDMS). In embodiments, the functionalized polysiloxane may be a (meth)acrylate ester functionalized polydimethylsiloxane (f-PDMS), where (meth)acrylate function attached to the PDMS via a bridge.

In embodiments, the copolymer optionally comprises one or more units derived from a termonomer. The termonomer may be selected from the group consisting of an olefin, an unsaturated ester, an unsaturated acid, a functionalized alkene, and combinations thereof.

### Functionalized Polysiloxane

The polysiloxane can be any of a diverse class of polymers manufactured as fluids, resins, or elastomers. Polysiloxanes are partially organic compounds, but, unlike most polymers, they have a backbone containing no carbon, composed instead of alternating silicon and oxygen atoms, as shown above. Although in the structural formulas shown above, each silicon is illustrated as being bound to a methyl and/or R groups, it is contemplated that each of those positions can individually be an alkyl, vinyl, phenyl, hydrogen, hydroxyl, acetoxy, enoxy, oxime, methoxy, ethoxy, alkoxy, dimethylamino, aminopropyl, hydroxypropyl, mercaptopropyl, chloropropyl, acryloxyprogpyl, methacryloxypropyl, epoxypropoxypropyl, or epoxycyclohexylethyl. In embodiments, each position is methyl.

In some embodiments, x is sufficiently large such that the polysiloxane has a viscosity of 100 or more, 200 or more, or 500 or more, centistokes (CST). In embodiments, x is no larger than would produce a polysiloxane with a viscosity no greater than 2.5 million CST. However it is contemplated that the upper limit on the viscosity is lower than 2.5 million CST, for example, 1 million or 600,000 CST.

Polysiloxanes suitable for use in various embodiments include those described in U.S. Pat. No. 6,239,244, the entire contents of which is hereby incorporated by reference in its entirety. The polysiloxanes, and are commercially available from a number of different manufacturers including, but not limited to Dow, Momentive, Wacker, Shin-Etsu, and Evonik.

According to embodiments, the release liner may comprise a copolymer comprising low density polyethylene and (a) (meth)acrylic ester functionalized polysiloxane, (b) a vinyl functionalized polysiloxane, or a mixture thereof.

In various embodiments described herein, the polysiloxane is a polydimethylsiloxane (PDMS) that includes one or more functional groups and is, therefore, referred to a functionalized PDMS, or f-PDMS. In various embodiments, the f-PDMS is a (meth)acrylate ester functionalized PDMS, where the (meth)acrylate ester group is bonded to the PDMS through a bridge group, or vinyl functionalized PDMS, where the vinyl group is attached directly to any of the silicon atoms of PDMS. The PDMS may be monofunctional or difunctional or polyfunctional, and the functional group(s) may be linked at a terminal or pendant location on the siloxane. Accordingly, in embodiments, the f-PDMS comprises one of the following structures or combinations thereof:

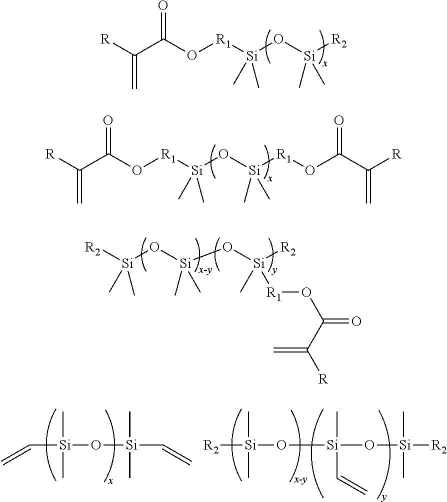

where R is methyl or hydrogen, R¹ is a bridge group, R² is an end group selected from alkyl, aryl, alkenyl, H, or OH, x is an integer from 10 to 1000, and y is an integer from 1 to 30.

### Process-Functionalized Polysiloxane

In various embodiments, each of the bridge groups is determined by the method in which the siloxane backbone is linked to the (meth)acrylate functionality. In some embodiments, the siloxane backbone is linked to the (meth)acrylate functionality through direct hydrosilylation of an alkenyl (meth)acrylate, hydrosilylation using an SiH functional (meth)acrylate converter, or equilibration/condensation with a (meth)acrylate functional alkoxy silane. Other methods for linking the siloxane backbone and the (meth)acrylate functionality are contemplated and may be used, depending on the particular embodiment.

### Process-Copolymers of Ethylene and Functionalized Polysiloxane

In various embodiments, the LDPE-co-PDMS is formed in the presence of ethylene. In embodiments, the LDPE-co-PDMS is produced via a high pressure, free-radical polymerization process. Two different high pressure free-radical initiated polymerization process types are known. In the first process type, an agitated autoclave reactor having one or more reaction zones is used. The autoclave reactor includes several injection points for initiator or monomer feeds, or both. In the second process type, a jacketed tube is used as a reactor, which has one or more reaction zones. Suitable reactor lengths include, but are not limited to, from 100 to 3000 meters (m), or from 1000 to 2000 m. The beginning of a reaction zone, for either type of reactor, is typically defined by the side injection of initiator of the reaction, ethylene, chain transfer agent (or telomer), comonomer(s), or combinations thereof. A high pressure process can be carried out in autoclave reactors or tubular reactors having one or more reaction zones, or in a combination of autoclave reactors and tubular reactors, each comprising one or more reaction zones.

In various embodiments, chain transfer agents (CTAs) may be used to control polymer properties, including but not limited to, molecular weight of the resultant polymer and the melt index. Chain transfer involves the termination of growing polymer chains, thus limiting the ultimate molecular weight of the polymer material. Chain transfer agents are typically hydrogen atom donors that will react with a growing polymer chain and stop the polymerization reaction of the chain. For high pressure free radical polymerization, CTAs can be of many different types, such as saturated hydrocarbons, unsaturated hydrocarbons, aldehydes, ketones, or alcohols. Non-limiting examples of CTAs include propylene, isobutane, n-butane, 1-butene, methyl ethyl ketone, acetone, ethyl acetate, propionaldehyde, products available under the tradename ISOPAR (available from ExxonMobil Chemical Co.), and isopropanol. In embodiments, the amount of CTA used in the process is from 0.01 wt % to 10 wt % of the total reaction mixture.

In embodiments, the free radical initiator can include a CTA as a solvent or as a blend for simultaneous injection with ethylene. For example, a CTA may be blended with ethylene, pressurized, and then injected into the reactor.

In various embodiments, one or more free radical initiators are used to produce the LDPE-co-PDMS. Free radical initiators that are generally used to produce ethylene-based polymers, such as LDPE, are oxygen and peroxides. Non-limiting examples of free radical initiators include t-butyl peroxy pivalate, di-t-butyl peroxide, t-butyl peroxy acetate (TPA), t-butyl peroxyoctoate (TPO), t-butyl peroxy-2-hexanoate, and combinations thereof. Other initiators known and used in the art are contemplated. In embodiments, the initiator is included in conventional amounts, such as from 0.005 wt % to 0.2 wt % based on the weight of polymerizable monomers. In embodiments, the initiator is injected prior to the reaction zone or within the reaction zone where free radical polymerization is to be induced. Termination of catalyst activity may be achieved by a combination of high reactor temperatures for the free radical polymerization portion of the reaction, or by feeding initiator into the reactor dissolved in a mixture of a polar solvent such as propanol, water, or conventional initiator solvents, such as branched or unbranched alkanes. In embodiments, the free radical initiator initiate polyethylene chain formation, followed by an attack of this propagating chain onto functional group of the f-PDMS (e.g., the (meth)acrylate ester group), followed by further reaction of the freshly formed α-carbonyl radical with ethylene monomers thus enabling the ethylene (in either monomeric or polymeric form) to attach to the (meth)acrylate ester.

In embodiments, at least one hydrocarbon solvent may be included in the free radical initiator system. The hydrocarbon solvent may, for example, be a C₅ to C₃₀ hydrocarbon solvent. Exemplary hydrocarbon solvents include, by way of example and not limitation, mineral solvents, normal paraffinic solvents, isoparaffinic solvents, cyclic solvents, and the like. In embodiments, the hydrocarbon solvents are selected from the group consisting of n-octane, iso-octane (2,2,4-trimethylpentane), n-dodecane, iso-dodecane (2,2,4,6,6,-pentamethylheptane), and other isoparaffinic solvents. Example hydrocarbon solvents such as isoparaffinic solvents, for example, are commercially available under the trademarks ISPAR C, ISOPAR E, and ISOPAR H from ExxonMobil Chemical Co. In embodiments, the hydrocarbon solvent comprises less than 99 wt % of the free radical initiator system.

Embodiments may further include a polar co-solvent, such as an alcohol co-solvent (e.g., a C₁ to C₃₀ alcohol), an aldehyde, a ketone, or an ester. The alcohol functionality of the alcohol co-solvent may be mono-functional or multi-functional. Suitable alcohol co-solvents can include, by way of example and not limitation, isopropanol (2-propanol), allyl alcohol, 1-pentanol, methanol, ethanol, propanol, 1-butanol, 1,4-butanediol, combinations thereof, or mixtures thereof. In embodiments, the polar co-solvent may be included in an amount of less than 40 wt % of the free radical initiator system.

Other additives, such as processing aids, plasticizers, stabilizers, ultraviolet light absorbers, antistatic agents, pigments, dyes, nucleating agents, fillers, slip agents, fire retardants, lubricants, smoke inhibitors, viscosity control agents, and anti-blocking agents. In embodiments, one or more of the additives are included in an amount of less than 20 wt % of the combined weight of the additives, based on the weight of the polymer.

In embodiments, the process includes a process recycle loop to further improve conversion efficiency. In such embodiments, the downstream reaction area or zone is maintained at a temperature that is lower than that at which the ethylene-based polymer would phase separate from the polysiloxane. In embodiments, the recycle loop may be treated to neutralize residues or byproducts from the previous reaction cycle, since such residues or byproducts may inhibit polymerization of either the polysiloxane or the ethylene-based polymer.

Ethylene, f-PDMS, initiator, and CTA are each added to the reactor at one or more locations to achieved desired ratios of components in the feeds to and or in the reaction zones of the reactor. As will be appreciated by those skilled in the art, the choice of feed point for each component into the reactor and/or a reaction zone depends on several factors, including, but not limited, to the solubility and/or condensation of components in pressurized ethylene and/or fouling that may occur in the pre-heater used to heat the reactor contents prior to injection of the initiator.

Ethylene used for the production of the LDPE-co-PDMS may be purified ethylene obtained by removing polar components from a loop recycle stream or a reaction system configuration in which only fresh ethylene is used for making the LDPE-co-PDMS polymer.

In embodiments, the polymerization is carried out in a continuously stirred tank reactor using propylene as a chain transfer agent. Ethylene and propylene are fed to the top of the reactor along the agitator shaft. In embodiments, tert-butyl peroxyacetate (TPA) and tert-butyl peroxyoctoate (TPO) are used as initiators injected into the side of the reactor. In embodiments, the f-PDMS is separately injected into the side of the reactor.

In embodiments, the maximum temperature in each reaction zone is from 150° C. to 360° C., from 170° C. to 350° C., or from 200° C. to 325° C. In embodiments, the polymerization pressure at the inlet of the reactor is from 100 MPa to 360 MPa, from 150 MPa to 340 MPa, or from 185 MPa to 320 MPa. Following polymerization, the contents of the reactor, including unreacted reactants and the LDPE-co-PDMS polymer, are emitted from an outlet of the reactor.

The LDPE-co-PDMS polymer may be separated from any remaining reactants according to any method known and used in the art. In embodiments, atomization is used to separate the LDPE-co-PDMS polymer from the remaining reactants, and the LDPE-co-PDMS polymer is collected in powder form.

Although certain particular LDPE-co-PDMS structures are illustrated in the figures and structures presented herein, it is contemplated that other structures are possible and contemplated. Additionally, in embodiments, the LDPE-co-PDMS polymer is present in a blend comprising one or more of the structures depicted herein. For example, in embodiments, in addition to attachment of the f-PDMS to LDPE by copolymerizing the double bond of the functional group with ethylene, the reaction may also yield some amount of byproduct where LDPE is attached to PDMS through methyl group of the PDMS via chain transfer mechanism. Moreover, it should be appreciated that the LDPE-co-PDMS may constitute only a small amount of the reaction product, with a major portion of the reaction product being LDPE. In embodiments, the LDPE-co-PDMS is present in a blend comprising at least one additional polymer. The additional polymer can be, for example, low density polyethylene (LDPE), linear low density polyethylene (LLDPE), ultra low density polyethylene (ULDPE), very low density polyethylene (VLDPE), medium density polyethylene (MDPE), high density polyethylene (HDPE), a copolymer including a (meth)acrylate ester, a copolymer comprising (meth)acrylic acid, mono- or diester of maleic acid, a copolymer comprising vinyl acetate, a copolymer comprising trialkoxy vinylsilane, grafted polyethylenes, or derivatives or combinations thereof.

In embodiments, the LDPE-co-PDMS may have a polydispersity index (PDI) of from 3.0 to 50.0, such as from 5.0 to 45.0, from 5.0 to 40.0, from 5.0 to 35.0, from 5.0 to 30.0, from 5.0 to 20.0, or from 5.0 to 15.0. In embodiments, the LDPE-co-PDMS may have a melt index (I₂) of from 0.1 to 500.00 g/10 min, such as from 0.15 to 100.00 g/10 min, from 0.15 to 25.00 g/10 min, from 0.15 to 10.00 g/10 min, from 0.50 to 10.00 g/10 min, or from 0.50 to 7.50 g/10 min.

As understood by those skilled in the art, the elemental composition of the surface of the inventive release liners may be determined using x-ray photoelectron spectroscopy (“XPS”). In embodiments disclosed herein, XPS may be used to quantify the amount of silicon on the surface of the release liners formed from the LDPE-co-PDMS polymer as a percentage of the total elemental composition. In embodiments, the atomic percentage or mole percentage of silicon on the surface of the release liners formed from the LDPE-co-PDMS polymer may be from 3.00% to 10.00%, such as from 3.00% to 4.00%, from 4.00% to 5.00%, from 5.00% to 6.00%, from 6.00% to 7.00%, from 7.00% to 8.00%, from 8.00% to 9.00%, or from 9.00% to 10.00%.

Using procedures understood to those skilled in the art, the release force of the inventive release liners may be determined at various peeling speeds since different downstream applications have different release force requirements. The release force is the force required to separate a release liner from a pressure sensitive adhesive. The release force of a release liner may vary, according to how long the release liner is in contact with the pressure sensitive adhesive. In embodiments disclosed herein, release liners comprising the LDPE-co-PDMS polymer may exhibit a release force from 0.154 Newtons per centimeter (“N/cm”) to 1.35 N/cm, such as from 0.154 N/cm to 0.386 N/cm, from 0.386 N/cm to 0.579 N/cm, from 0.579 N/cm to 0.772 N/cm, from 0.772 N/cm to 0.965 N/cm, from 0.965 N/cm to 1.16 N/cm, or from 1.16 N/cm to 1.35 N/cm.

The use of the release liner should not adversely affect the performance of the adhesive. Therefore, the migration of silicone or other species from the release liner to the adhesive must be minimized to avoid negatively impacting the adhesion strength of the adhesive. Using procedures understood to those skilled in the art, the subsequent adhesion strength (“SAS”) associated with the inventive release liners may be assessed. “Adhesion strength” is the force required to remove a unit width of pressure sensitive tape from a standard stainless-steel panel. The SAS is the adhesion strength of a “test tape” after it has been in contact with a release liner for a given period of time. The SAS of a test tape is expressed as a percentage of the adhesion strength of the same tape (“fresh tape”) that has not been in contact with the release liner, as show in Equation 1.

$$Equation 1$$

$$SAS = ( \frac{adhesion strength of test tape after contact with release liner}{adhesion strength of fresh tape} ) \times 100$$

Equation 1 shows that the greater the effect a release liner has on the adhesion strength of a test tape, the more the SAS value for that test tape will deviate from 100%. Because a loss in adhesion strength can be attributed to silicone migration from the release liner to the test tape, it follows that a higher SAS value indicates less silicone migration. This, in turn, correlates with better release liner performance. In embodiments disclosed herein, the SAS of pressure sensitive tape that has been in contact with the inventive release liners for a period of time may be from 70% to 100%, such as from 70% to 80%, from 80% to 90%, or from 90% to 100%.

### EXAMPLES

### Example 1: Synthesis of LDPE-Co-PDMS Hybrid Polymer

Sample Formulations (Table 1, F1-F8) of the LDPE-co-PDMS polymer were synthesized as follows:

Polymerization was carried out in a continuously stirred tank reactor with a volume of 300 mL heated to 220° C. using four electric heater bands. The agitator speed was 1800 revolutions per minute (RPM). The reactor pressure was controlled to approximately 193 MPa. Propylene was used as a chain transfer agent. Ethylene and propylene were fed to the top of the reactor along the agitator shaft at a flow rate of 5440-5470 g/h ethylene. Tert-butyl peroxyacetate (“TPA”) and tert-butyl peroxyoctoate (“TPO”) were used as initiators in a 0.61:1 mass ratio. The initiators were diluted in ISOPAR E (available from ExxonMobil Chemical Co.) and injected into the side of the reactor at a pressure of 193 MPa at a ratio of 30-33 mass ppm TPA and 50-54 mass ppm TPO to ethylene. For each Formulation, a functionalized polysiloxane according to Table 1 was diluted in Isopar E to 30 wt % and injected into the side of the reactor.

The reactor residence time was about 1.5 minutes. All unreacted reactants and polymer were emitted via a single outlet located on the bottom of the reactor. The LDPE-co-PDMS hybrid polymer product was then separated from the remaining reactants by atomization, depressurizing the stream to about 0.1 MPa and simultaneously cooling the stream to ambient temperatures. Finally, the LDPE-co-PDMS hybrid polymer was collected in powder form.

The parameters of each LDPE-co-PDMS polymer sample Formulation are shown in Table 1.

TABLE 1

| | | % wt | Melt |
|---|---|---|---|
| | | f- | Index |
| | | PDMS | of |
| Polymer | | in | Polymer |
| Formula- | | Poly- | (g/10 |
| tion | f-PDMS Structure | mer | min) |
| F1 F2 F3 | 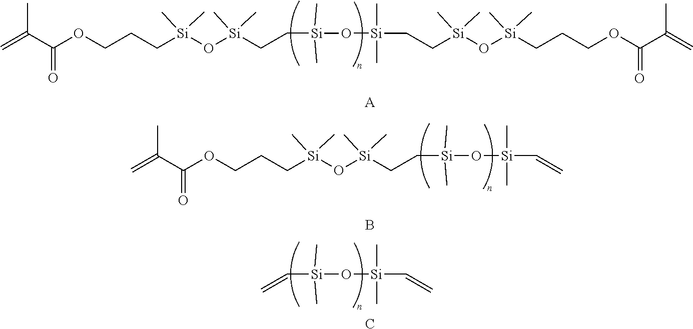 | 10.00% 7.50% 5.00% | 2.0 1.8 1.9 |
| | A/B/C - 1/2/1, n =182 | | |
| F4 F5 F6 | 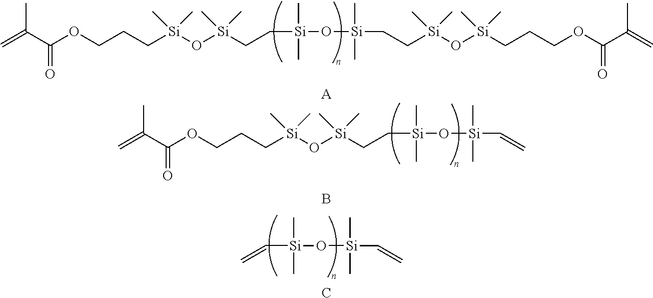 | 13.00% 7.00% 4.50% | 7.4 3.3 3.0 |
| | A/B/C - 1/2/1, n = 292 | | |
| F7 F8 | 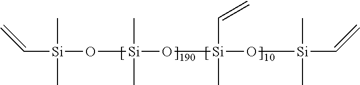 [SMILES: C=C[Si](C)(C)O[Si](C)(C)O[Si](C)(C=C)O[Si](C)(C)C=C] | 5.3% 4.50% | 3.3 2.4 |

### Example 2: Analysis of Release Liner Surface

To evaluate the mechanical properties of the LDPE-co-PDMS hybrid polymers in release liner applications, Sample release liners (S1-S8) were prepared from LDPE-co-PDMS polymer Formulations 1-8. A release liner sheet of each Formulation was prepared by extrusion. X-photoelectron spectroscopy (“XPS”) was used to determine the elemental composition of the surface of the inventive Sample release liners, S1-S8.

The XPS data were acquired using a PHI VersaProbe II XPS under the following analysis conditions:

| X-ray Source: | Monochromatic Al Ka |
|---|---|
| | 200 mm, 50 W, 15 kV |
| Electron Neutralizer: | 20 mA, bias 0.99 V |
| Ion Gun Neutralizer: | 3 mA, 7 V bias |
| Analyzer Mode: | Scanned mode |
| Analyzer Pass Energy: | (survey spectra) 187.85 eV |
| Step Size: | 0.8 eV |
| Analysis Area (16-84% Signal Level): | 200 mm spot |
| Number of Analysis Areas: | 3 |
| Take-Off Angle | 45° |

For each Sample release liner (S1-S8), a small piece was cut in the middle of the sample and mounted on a 60 mm platen using a double-sided tape. The amount of each element on the surface of each sample was quantified from the integrated peak intensities under the indicated transition according to Equation 1, which accounts for the instrument-specific cross section (sensitivity factor) for a PHI VersaProbe II spectrometer. The elemental compositions were calculated assuming that the elements detected account for 100% of the species on the surface (note that XPS is not sensitive for hydrogen and helium).

$${C}_{i} = \frac{( {A}_{i} / {S}_{i} )}{{\sum }_{i} ( {A}_{i} / {S}_{i} )} \times 100 ( \% ) \qquad [ Equation 1 ]$$

“Cᵢ” is the surface concentration of element i, “Aᵢ” is the integrated area of the photoelectron peak of element i, and “Sᵢ” is the instrument dependent sensitivity factor of element i.

The error in the composition calculated in this manner comes from two sources: (1) spatial heterogeneity of the sample and (2) measurement errors. The spatial heterogeneity is estimated by triplicate measurements. The measurement error is estimated as <5% relative plus 0.5 times the detection threshold for the element of interest.

The percentage of silicon on the surface of each Sample (S1-S8), based on the quantification of the silicon 2p-electrons, is shown in Table 2.

TABLE 2

| | S1 | S2 | S3 | S4 | S5 | S6 | S7 | S8 |
|---|---|---|---|---|---|---|---|---|
| XPS Si 2p (%) | 7.2 | 5.0 | 3.4 | 9.0 | 8.3 | 6.1 | 5.8 | 6.8 |

The XPS data confirmed the accumulation of PDMS on the surface of the release liner samples.

### Example 3: Release Force Test

The release liner sheets were laminated with Tesa 7475 industrial standard tape (25 mm width and 200 mm long). The laminated sheets were aged under weight of 20 grams per centimeters squared in a controlled temperature (23° C.) and a controlled humidity room (50% relative humidity) for a duration of time. The laminated sheets were then cut into strips. The strips were tested on an IMASS ZPE-1100W release test system at medium to high delamination speed (10 m/min, 100 m/min, or 300 m/min) using a 180° degree peeling method. Each sample was tested in triplicate. Table 3 shows the average result for each inventive Sample Liner (S1-S8) at each delamination speed after (A) 7 days, (B) 1 month, and (C) 3 months of aging. Also in Table 3 are the average results for Comparative Sample Liner 1 (CS1), comprising only LDPE (no PDMS co-polymer), at each delamination speed after (A) 7 days, (B) 1 month, and (C) 3 months of aging.

TABLE 3

| | | Hybrid Polymer Formulation | | | | |
|---|---|---|---|---|---|---|
| | | F1 | F2 | F3 | F4 | F5 |
| | Percent Weight PDMS | 10.00 | 7.50 | 5.00 | 13.00 | 7.00 |
| | | Average Release Force (N/cm) | | | | |
| Age | Delamination Speed | S1(A) | S2(A) | S3(A) | S4(A) | S5(A) |
| 7 days | 10 m/min | 0.94719 | 1.1428 | 1.0166 | 1.1801 | 1.09004 |
| | 100 m/min | 0.89445 | 0.80433 | 0.87769 | 0.89186 | 0.90730 |
| | 300 m/min | 0.51994 | 0.57913 | 0.89186 | 0.56241 | 0.56496 |
| | | S1(B) | S2(B) | S3(B) | S4(B) | S5(B) |
| 1 month | 10 m/min | 0.74673 | 0.75403 | 0.77970 | 0.82337 | 0.80835 |
| | 100 m/min | 0.46288 | 0.44176 | 0.69233 | 0.73661 | 0.56743 |
| | 300 m/min | 0.20605 | 0.20250 | 0.32856 | 0.45836 | 0.33771 |
| | | S1(C)S2( | S4(C) | S5(C) | | |
| 3 months | 10 m/min | 0.88839 | 0.87159 | 0.92958 | 0.88580 | 0.87653 |
| | 100 m/min | 0.45624 | 0.55191 | 0.50450 | 0.55635 | 0.49805 |
| | 300 m/min | 0.19624 | 0.43492 | 0.24902 | 0.27539 | 0.21593 |
| | | Hybrid Polymer Formulation | | | | |
| | | F6 | F7 | F8 | LDPE | |
| | Percent Weight PDMS | 4.50 | 6.00 | 4.50 | 0.00 | |
| | | Average Release Force (N/cm) | | | | |
| Age | Delamination Speed | S6(A) | S7(A) | S8(A) | CS1(A) | |
| 7 days | 10 m/min | 0.95236 | 1.0038 | 0.90217 | TT* | |
| | 100 m/min | 0.69623 | 0.60488 | 0.79275 | TT | |
| | 300 m/min | 0.51091 | 0.55982 | 0.55338 | TT | |
| | | S6(B) | S7(B) | S8(B) | CS1(B) | |
| 1 month | 10 m/min | 0.71160 | 0.73233 | 1.0162 | TT | |
| | 100 m/min | 0.44836 | 0.44639 | 0.50164 | TT | |
| | 300 m/min | 0.23586 | 0.22636 | 0.27898 | TT | |
| | | S6(C) | S7(C) | S8(C) | CS1(C) | |
| 3 months | 10 m/min | 0.86703 | 0.83653 | 0.82712 | TT | |
| | 100 m/min | 0.43848 | 0.47631 | 0.46049 | TT | |
| | 300 m/min | 0.21339 | 0-22675 | 0.18814 | TT | |

*TT—the release force was too high to be tested.

As shown by the data in Table 3, the LDPE liner demonstrated a release force too high to be tested and did not allow for the smooth separation of the test tape from the release liner. However, the release liners that included PDMS demonstrated dramatically lower release force values and allowed for relatively smooth separation of the test tape from the release liner.

### Example 4: Subsequent Adhesion Strength Test

After the release testing, the Tesa 7475 adhesive tape was pulled off each Sample Liner and reserved. The tape was laminated to a stainless-steel test panel using four passes of a 4.5 lb rolling weight and left to rest for 20 minutes. The tape on the panel was then tested using a TMI peel/adhesion tester. The adhesive tape was pulled at 0.3 m/min at a 180° angle. For Comparative Sample 2 (CS2), fresh 7475 tape was subjected to the method described above. Each sample was tested in triplicate. The average “subsequent adhesion strength” (“SAS”) for each sample (S1-S8 and CS2) is shown in Table 4.

TABLE 4

| | Subsequent Adhesion Strength (%) | | | | | | | | |
|---|---|---|---|---|---|---|---|---|---|
| | S1 | S2 | S3 | S4 | S5 | S6 | S7 | S8 | CS2 |
| (A) (7 day age) | 97.47 | 84.23 | 75.27 | 78.94 | 78.97 | 78.97 | 91.60 | 82.88 | 95.03 |
| (B) (1 month age) | 95.35 | 83.74 | 86.34 | 78.59 | 87.32 | 76.71 | 79.87 | 91.36 | 83.74 |
| (C) (3 month age) | 100.00 | 85.07 | 100.00 | 98.22 | 100.00 | 84.93 | 94.00 | 95.19 | 87.75 |

As previously discussed, a greater SAS value correlates with less loss in adhesion strength due to contact with the release liner and, thus, indicates less silicone migration from the release liner to the tape. The incorporation of PDMS into polyethylene resulted in relatively high SAS, indicating good control of silicone migration and good maintenance of tape adhesion strength, which is important for downstream applications of the tape.

The present disclosure includes several aspects. A first aspect is a process for making a laminated sheet, the process comprising: applying an uncured adhesive to a removable layer such that a first surface of the removable layer is in direct contact with an uncured adhesive; curing the uncured adhesive to form a cured adhesive layer positioned in direct contact with the first surface of the removable layer; and applying a release liner in direct contact with the cured adhesive layer such that the cured adhesive layer is positioned between the removable layer and the release liner; wherein the release liner comprises a copolymer comprising low density polyethylene and one or more functionalized polysiloxanes, wherein the functionalized polysiloxanes are chosen from (meth)acrylic ester functionalized polysiloxane and vinyl functionalized polysiloxane.

Another aspect is the aspect listed is the paragraph immediately above, wherein the applying the uncured adhesive to the removable layer is performed as the removable layer is translated in a machine direction; the curing the uncured adhesive is performed as the removable layer is translated in the machine direction; and the applying the release liner in direct contact with the cured adhesive layer is performed as the removable layer is translated in the machine direction.

Another aspect is a process for making a laminated sheet, the process comprising: applying an uncured adhesive to a release liner such that a first surface of the release liner is in direct contact with an uncured adhesive; curing the uncured adhesive to form a cured adhesive layer positioned in direct contact with the first surface of the release liner; and applying a removable layer in direct contact with the cured adhesive layer such that the cured adhesive layer is positioned between the removable layer and the release liner; wherein the release liner comprises a copolymer comprising low density polyethylene and one or more functionalized polysiloxanes, wherein the functionalized polysiloxanes are chosen from (meth)acrylic ester functionalized polysiloxane and vinyl functionalized polysiloxane.

Another aspect is the aspect of the paragraph immediately above, wherein: the applying the uncured adhesive to a release liner is performed as the release liner is translated in a machine direction; the curing the uncured adhesive is performed as the release liner is translated in a machine direction; and the applying the removable layer in direct contact with the cured adhesive layer is performed as the release liner is translated in a machine direction.

Another aspect is any preceding aspect, wherein the release liner has a homogenous composition.

Another aspect is any preceding aspect, wherein the removable layer comprises one or more of paper, vinyl, polyester, polypropylene, foil, and fabric.

Another aspect is any preceding aspect, wherein the process does not include a step of applying a silicone liner.

Another aspect is any preceding aspect, wherein the cured adhesive is chosen from acrylic adhesives, rubber adhesives, hot melt adhesives, water-based adhesives, solvent-based adhesives, pressure sensitive adhesives, synthetic rubber adhesives, or combinations thereof.

Another aspect is any preceding aspect, wherein the curing the uncured adhesive is by exposure to heat, radiation, or catalyst.

Another aspect is any preceding aspect, wherein the copolymer further comprises one or more units derived from a termonomer.

Another aspect is any preceding aspect, wherein one or both of: the (meth)acrylic ester functionalized polysiloxane is (meth)acrylic ester functionalized polydimethylsiloxane; or the vinyl functionalized polysiloxane is vinyl functionalized polydimethylsiloxane.

Another aspect is any preceding aspect, wherein the copolymer comprises one or more of the following structures:

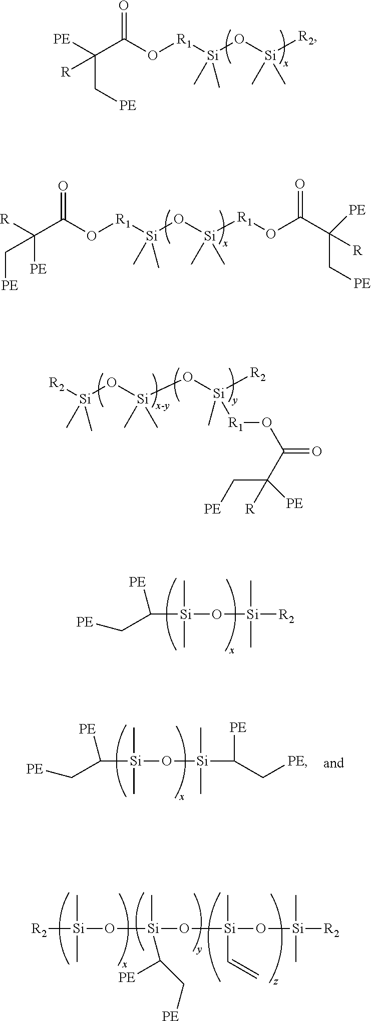

wherein R is methyl or hydrogen, R1 is a bridge group that connects functional group ((meth)acrylate) with siloxane, R2 is an end group selected from the group consisting of alkyl, substituted alkyl, aryl, alkenyl, H, and OH, x is an integer from 10 to 1000, y is an integer from 1 to 30, z is any integer 0 to 30, and y+z is less than or equal to 30.

Another aspect is any preceding aspect, wherein one or more functionalized polysiloxanes has a structural formula of one or more of the following:

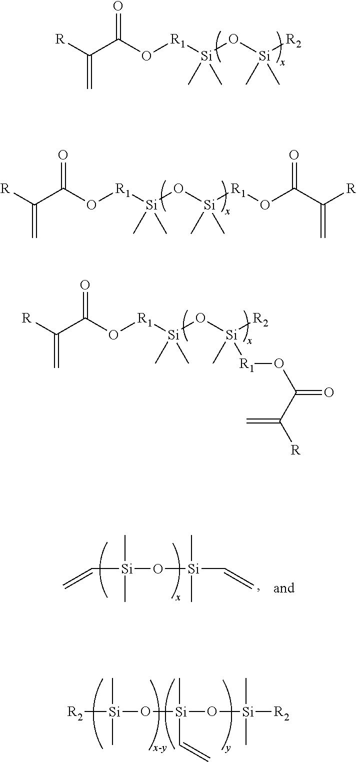

where R is methyl or hydrogen, R1 is a bridge group, R2 is an end group selected from alkyl, aryl, alkenyl, H, or OH, x is an integer from 10 to 1000, and y is an integer from 1 to 20.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. A process for making a laminated sheet, the process comprising:
applying an uncured adhesive to a removable layer such that a first surface of the removable layer is in direct contact with an uncured adhesive;
curing the uncured adhesive to form a cured adhesive layer positioned in direct contact with the first surface of the removable layer; and
applying a release liner in direct contact with the cured adhesive layer such that the cured adhesive layer is positioned between the removable layer and the release liner;
wherein the release liner comprises a copolymer comprising low density polyethylene and one or more functionalized polysiloxanes, wherein the functionalized polysiloxanes are chosen from (meth)acrylic ester functionalized polysiloxane and vinyl functionalized polysiloxane.

2. The process of claim 1, wherein:
the applying the uncured adhesive to the removable layer is performed as the removable layer is translated in a machine direction;
the curing the uncured adhesive is performed as the removable layer is translated in the machine direction; and
the applying the release liner in direct contact with the cured adhesive layer is performed as the removable layer is translated in the machine direction.

3. A process for making a laminated sheet, the process comprising:
applying an uncured adhesive to a release liner such that a first surface of the release liner is in direct contact with an uncured adhesive;
curing the uncured adhesive to form a cured adhesive layer positioned in direct contact with the first surface of the release liner; and
applying a removable layer in direct contact with the cured adhesive layer such that the cured adhesive layer is positioned between the removable layer and the release liner;
wherein the release liner comprises a copolymer comprising low density polyethylene and one or more functionalized polysiloxanes, wherein the functionalized polysiloxanes are chosen from (meth)acrylic ester functionalized polysiloxane and vinyl functionalized polysiloxane.

4. The method of claim 3, wherein:
the applying the uncured adhesive to a release liner is performed as the release liner is translated in a machine direction;
the curing the uncured adhesive is performed as the release liner is translated in a machine direction; and
the applying the removable layer in direct contact with the cured adhesive layer is performed as the release liner is translated in a machine direction.

5. The process of claim 3, wherein the release liner has a homogenous composition.

6. The process of claim 3, wherein the removable layer comprises one or more of paper, vinyl, polyester, polypropylene, foil, and fabric.

7. The process of claim 3, wherein the process does not include a step of applying a silicone liner.

8. The process of claim 3, wherein the cured adhesive is chosen from acrylic adhesives, rubber adhesives, hot melt adhesives, water-based adhesives, solvent-based adhesives, pressure sensitive adhesives, synthetic rubber adhesives, or combinations thereof.

9. The process of claim 3, wherein the curing the uncured adhesive is by exposure to heat, radiation, or catalyst.

10. The process of claim 3, wherein the copolymer further comprises one or more units derived from a termonomer.

11. The process of claim 3, wherein one or both of:
the (meth)acrylic ester functionalized polysiloxane is (meth)acrylic ester functionalized polydimethylsiloxane; or
the vinyl functionalized polysiloxane is vinyl functionalized polydimethylsiloxane.

12. The process of claim 3, wherein the copolymer comprises one or more of the following structures: 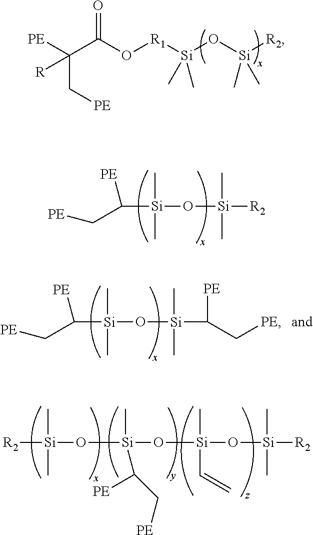
wherein R is methyl or hydrogen, R¹ is a bridge group that connects functional group ((meth)acrylate) with siloxane, R² is an end group selected from the group consisting of alkyl, substituted alkyl, aryl, alkenyl, H, and OH, x is an integer from 10 to 1000, y is an integer from 1 to 30, z is any integer 0 to 30, and y+z is less than or equal to 30.

13. The process of claim 3, wherein one or more functionalized polysiloxanes has a structural formula of one or more of the following: 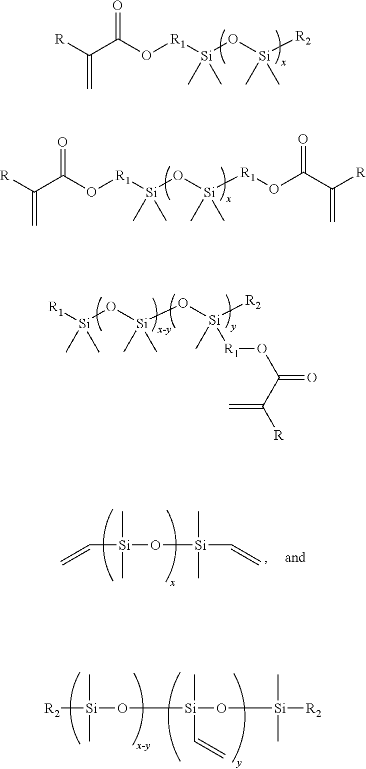
where R is methyl or hydrogen, R₁ is a bridge group, R₂ is an end group selected from alkyl, aryl, alkenyl, H, or OH, x is an integer from 10 to 1000, and y is an integer from 1 to 20.

14. The process of claim 1, wherein the release liner has a homogenous composition.

15. The process of claim 1, wherein the removable layer comprises one or more of paper, vinyl, polyester, polypropylene, foil, and fabric.

16. The process of claim 1, wherein the cured adhesive is chosen from acrylic adhesives, rubber adhesives, hot melt adhesives, water-based adhesives, solvent-based adhesives, pressure sensitive adhesives, synthetic rubber adhesives, or combinations thereof.

17. The process of claim 1, wherein the copolymer further comprises one or more units derived from a termonomer.

18. The process of claim 1, wherein one or both of:
the (meth)acrylic ester functionalized polysiloxane is (meth)acrylic ester functionalized polydimethylsiloxane; or
the vinyl functionalized polysiloxane is vinyl functionalized polydimethylsiloxane.

19. The process of claim 1, wherein the copolymer comprises one or more of the following structures: 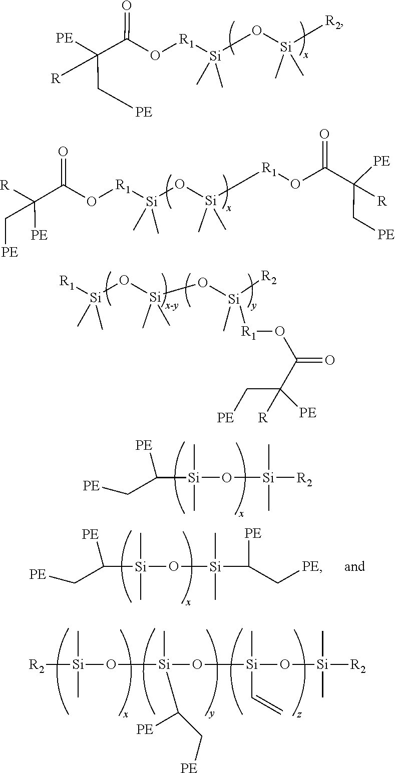
wherein R is methyl or hydrogen, R¹ is a bridge group that connects functional group ((meth)acrylate) with siloxane, R² is an end group selected from the group consisting of alkyl, substituted alkyl, aryl, alkenyl, H, and OH, x is an integer from 10 to 1000, y is an integer from 1 to 30, z is any integer 0 to 30, and y+z is less than or equal to 30.

20. The process of claim 1, wherein one or more functionalized polysiloxanes has a structural formula of one or more of the following: 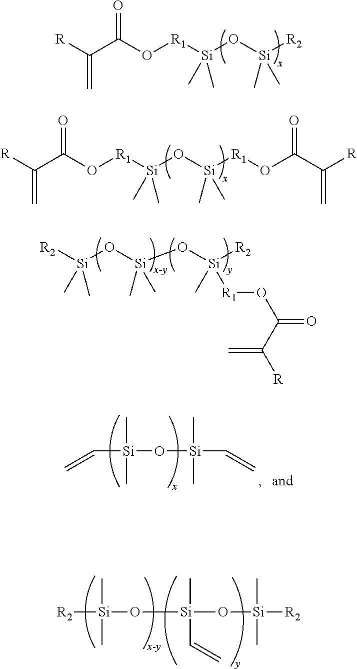
where R is methyl or hydrogen, R₁ is a bridge group, R₂ is an end group selected from alkyl, aryl, alkenyl, H, or OH, x is an integer from 10 to 1000, and y is an integer from 1 to 20.
